(19) United States
(12) Patent Application Publication
(10) Pub. No.: US 2005/0274164 A1
(43) Pub. Date: Dec. 15, 2005

(54) Combination grass colorant and fertilizer

(76) Inventors: Brian Coates, Modesta, CA (US); John McCormick, Modesta, CA (US)

Correspondence Address: Stephen E. Feldman, P.C., 12 East 41st Street, New York, NY, 10017, US

(21) Appl. No.: 10/868,251

(22) Filed: Jun. 14, 2004

(51) Int. Cl. C05C 1/00

(52) U.S. Cl. 71/31

(57) ABSTRACT

A ready-to-use lawn colorant and fertilizer composition is provided in a spray bottle. The composition includes a water-based lawn paint, fertilizer with nitrogen, phosphate and potash, and water.

### FIELD OF THE INVENTION

The present invention deals with fertilizers and more specifically, a combination grass fertilizer and colorant.

### BACKGROUND OF THE INVENTION

As lawns wither into a yellow or light brown color in-winter, colorant compositions with green or blue pigments contained therein have conventionally been sprayed to keep the lawns looking green.

In these colorant compositions, organic pigments and/or dyes such as copper phthalocyanine blue pigments and copper phthalocyanine green pigments have been employed for the purpose of coloring alone.

These conventionally-employed pigments and dyes are however intended merely to color lawns at their surfaces, and no physiological effects for plants are observed on their coloring components themselves.

Fertilizers of various compositions have been added to these colorants to aid the growth and development of lawns. One example is U.S. Pat. No. 2,714,062 to Lockrey et al., which purports to disclose a composition for and process of restoring the green color of grass.

U.S. Pat. No. 6,207,615 to Miller purports to disclose a lawn fertilizer for canine waste damage. U.S. Pat. No. 6,329,321 to Okra et al. purports to disclose a lawn colorant composition having rearing effects with a pigment and adhesive for the pigment.

None of the above references, however, provide a ready-to-use formulation for an ordinary end-user, such as a homeowner, to both fertilize and color grass. The prior art discloses industrial strength compositions not intended for the general public. To date, there is no readily available formula for the individual end-user to color and fertilize his lawn. Presently, any homeowner that wants to color his lawn has to hire a professional landscaper to do so. Oftentimes, however, homeowners prefer to take care of their own lawns and would not normally need their entire lawn colored, only small spots so it would be an excessive waste to hire a landscaper to color a few small patches of grass.

Lawn coloring is a sporadic need, without rhyme or reason, occurring with droughts, hot weather, and animal waste. These events happen at random, and so, the browning of grass, being a side effect, occurs at random as well. As a result, there is a need for a ready-to-use lawn fertilizer and colorant composition provided in a ready-to-use container.

### SUMMARY OF THE INVENTION

In accordance with an embodiment of the present invention, a combination fertilizer and colorant composition is provided. The composition is ready-to-use, and is provided in a ready-to-use container so that the composition is readily available for use immediately after purchase.

In more detail, the composition comprises a nutrient component, a coloring component and water. The nutrient component further comprises nitrogen based fertilizer, potash and phosphate.

Examples of acceptable nitrogen based fertilizer include ammonium sulphate, ammonium bicarbonate, calcium nitrate, sodium nitrate, ammonium nitrate, calcium ammonium nitrate, ammonium sulphate nitrate, calcium cyanamide, urea ammonium nitrate solution, nitrophosphate, monoammonium phosphate, diammonium phosphate, and liquid ammonium polyphosphates.

Examples of potash fertilizer include potassium chloride, potassium sulphate, and potassium magnesium sulphate.

A method of manufacturing a combination grass colorant and fertilizer is provided as well. The method comprises the steps of mixing 2-5% nutrient component by volume with 3-7% coloring component by volume and water to provide a combination composition, and providing the composition in a spray bottle.

### DETAILED DESCRIPTION

In accordance with an embodiment of the present invention, a combination fertilizer and colorant composition is provided. The composition is ready-to-use, and is provided in a ready-to-use container so that the composition is readily available for use immediately after purchase.

Fertilizers are substances that supply plant nutrients or amend soil fertility. Fertilizers are used in order to supplement the natural nutrient supply in the soil, especially to correct the (yield-limiting) minimum factor. Numerous mineral fertilizers have been developed to supplement soil nutrients and to meet the high requirements of crops. They are generally mineral salts, except for some organic chemicals such as urea which are easily converted into salts.

The present invention employs a mixed fertilizer, meaning a fertilizer having a physical mixture of two or more single-nutrient or multinutrient fertilizers. The composition is preferably provided in a spray bottle, or other liquid dispensing container, such as a spray can. The container should be able to spread an even layer of the composition over a particular surface. In addition, the container should be small enough so that it is easy to carry, but large enough to contain a good amount of the composition. A half gallon container would be ideal, but smaller sizes may be used, for example, a pint and a quart.

According to a preferred embodiment of the present invention, the composition comprises at least 3, preferably, 3-7 and most preferably around 4.7% by volume of water-based paint of a suitable color that best matches the natural color of green grass. At least 2, preferably 2-5 and most preferably around 3.1% fertilizer by volume for the nutrient component. The remainder of the composition is water.

The active ingredients for the nutrient component preferably include nitrogen, phosphate, and potash. It should be noted that the customary classification into single- or multi-nutrient fertilizers usually refers only to the three major nutrients. Many so-called single-nutrient fertilizers actually supply more than one nutrient, e.g. ammonium sulphate which contains both N and S. Therefore, a composition according to an embodiment of the present invention may include other active ingredients in conjunction with those listed above.

Nitrogen fertilizers are valued according to their total N-content, the different N-forms (which determine the rate of action) and side-effects if any. Acceptable nitrogen fertilizers include:
Ammonium fertilizers: ammonia (80% N), ammonium sulphate (21% N), ammonium bicarbonate (17% N), all moderately quick-acting. Uptake by plants can be retarded by addition of nitrification inhibitors, e.g. dicyandiamide (DCD).
Nitrate fertilizers: calcium nitrate (16% N), sodium nitrate (16% N), Chilean nitrate, all quick-acting and increasing soil pH.
Ammonium nitrate fertilizers: ammonium nitrate (about 34% N), calcium ammonium nitrate which is a combination of ammonium nitrate and calcium carbonate (21-27% N), ammonium sulphate nitrate (26-30% N).
Amide fertilizers: urea (45-46% N), calcium cyanamide (20% N).
Solutions containing more than one form of N: urea ammonium nitrate solution (28-32% N).
Slow release fertilizers: either derivatives of urea with N in large molecules, or granular water-soluble N fertilizers encased in thin plastic film, but slow or very slow-acting according to type of coating; partly including a quick-acting component.
Multinutrient fertilizers containing N:
[symbol] nitrophosphate=NP (20-23% N, 20-23% P₂O₅)
[symbol] monoammonium phosphate=MAP (11% N, 50% P₂O₅)
[symbol] diammonium phosphate=DAP (18% N, 46% P₂O₅)
[symbol] liquid ammonium polyphosphates (e.g. 12% N, 40% P₂O₅)

Nitrate N in the soil solution is immediately available and thus acts quickly but is most liable to leaching. Plants take up N mainly in nitrate form. Ammonium N, although fully available, has a somewhat slower effect, because it is first adsorbed and then only gradually released and nitrified.

Potash fertilizers are mainly derived from geological saline deposits. Although low-grade, unrefined materials can be used directly, most fertilizer use is now in the form of higher-concentration products, all of which are water-soluble and quick-acting. Some acceptable potash fertilizers include:
potassium chloride, or muriate of potash (40-60% K₂O), the lower grades providing Na in addition to K₂O, with or without Mg;
potassium sulphate (50% K₂O);
potassium magnesium sulphate, also known as sulphate of potash magnesia or Patentkali (e.g. 40% K₂O, 6% Mg).

A spray bottle is the preferred means for distribution of the composition for its accuracy of distribution, speed of application, and familiarity with the consuming public, making it easy to use. In addition, by providing the composition in a liquid form, it provides the possibility of incorporating pesticides or fungicides into the composition.

The combination grass colorant and fertilizer compositions of the present invention are illustrated in the following examples wherein all amounts are by volume.

### EXAMPLE 1

In a one quart container, there can be mixed 3.5% ammonium sulfate, 3.5% of a water based lawn paint having a dark green color and the remainder water.

### EXAMPLE 2

In a one quart container, there can be mixed 5% diammonium phosphate, 5% of a water based lawn paint having a light green color and the remainder water.

### EXAMPLE 3

In a one quart container, there can be mixed 2% urea ammonium nitrate solution, 3% of a water based lawn paint having a medium green hue and the remainder water.

### EXAMPLE 4

In a one pint container, there can be mixed 2% calcium nitrate, 2% nitrophosphate, 4% of a water based lawn paint having a dark green color and the remainder water.

### EXAMPLE 5

In a one pint container, there can be mixed 3% ammonium bicarbonate, 3% calcium cyanamide, 3.1% monoammonium phosphate, 4.7% of a water based lawn paint having a dark green color and the remainder water.

### EXAMPLE 6

In a one quart container, there can be mixed 5% liquid ammonium polyphosphate, 5% sodium nitrate, 1% potassium chloride, 3% of a water based lawn paint having a medium, green hue.

### EXAMPLE 7

In a one quart container, there can be mixed 2.5% calcium ammonium nitrate, 2.5% phosphorous, 1% potassium magnesium sulfate, 2.5% of a water based lawn paint having a medium green hue and the remainder water.

### EXAMPLE 8

In a one pint container, there can be mixed 4% sodium nitrate, 3% ammonium nitrate, 2% ammonium sulfate nitrate, 2% potassium sulfate, 5% of a water based lawn paint having a light green color and the remainder water.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

1. A combination grass colorant and fertilizer composition comprising:
a nutrient component;
a coloring component;
water;
wherein the nutrient component, coloring component, and water are provided in a ready-to-use container.

2. The composition of claim 1 wherein the nutrient component is a member selected from the group consisting of:
ammonium sulphate;
ammonium bicarbonate;
calcium nitrate;
sodium nitrate;
ammonium nitrate;
calcium ammonium nitrate;
ammonium sulphate nitrate;
calcium cyanamide;
urea ammonium nitrate solution;
nitrophosphate;
mono ammonium phosphate;
diammonium phosphate; and,
liquid ammonium polyphosphates, as well as combinations and mixtures thereof.

3. The composition of claim 1 wherein the nutrient component further comprises potash fertilizer.

4. The composition of claim 3 wherein the potash fertilizer is a member of the group consisting of potassium chloride, potassium sulphate, and potassium magnesium sulphate as well as combinations and mixtures thereof.

5. The composition of claim 1 wherein the nutrient component further comprises phosphorous.

6. The composition of claim 1 wherein the colorant component further comprises a water-based lawn paint.

7. The composition of claim 1 wherein the colorant component is 3-7% of the composition.

8. The composition of claim 1 wherein the nutrient component is 2-5% of the composition.

9. The composition of claim 1 further comprising a pesticide.

10. The composition of claim 1 further comprising a fungicide.

11. A combination grass colorant and fertilizer composition comprising:
2-5% nutrient component by volume;
3-7% coloring component by volume;
88-95% of water by volume;
wherein the nutrient component, coloring component, and water are provided in a ready-to-use container.

12. A method of manufacturing a combination grass colorant and fertilizer comprising the steps of:
mixing 2-5% nutrient component by volume with 3-7% coloring component by volume and water to provide a combination composition;
providing the composition in a spray bottle.

13. The method of claim 12 wherein the nutrient component is a member selected from the group consisting of:
ammonium sulphate;
ammonium bicarbonate;
calcium nitrate;
sodium nitrate;
ammonium nitrate;
calcium ammonium nitrate;
ammonium sulphate nitrate;
calcium cyanamide;
urea ammonium nitrate solution;
nitrophosphate;
mono ammonium phosphate;
diammonium phosphate; and,
liquid ammonium polyphosphates, as well as combinations and mixtures thereof.

14. The method of claim 12 wherein the nutrient component further comprises potash fertilizer.

15. The method of claim 12 wherein the potash fertilizer is a member of the group consisting of potassium chloride, potassium sulphate, and potassium magnesium sulphate as well as combinations and mixtures thereof.

16. The method of claim 12 wherein the nutrient component further comprises phosphorous.

17. The method of claim 12 wherein the colorant component further comprises a water-based lawn paint.

18. A method of using a combination grass colorant and fertilizer on yellow and brown grass patches found on an unhealthy lawn, comprising the steps of:
mixing a nutrient component, a coloring component and water to form said combination grass colorant and fertilizer;
providing the combination grass colorant and fertilizer in a spray bottle; and
spraying the composition on the yellow and brown grass patches.

19. The method of claim 18 wherein the nutrient component is a member selected from a group consisting of:
ammonium sulphate;
ammonium bicarbonate;
calcium nitrate;
sodium nitrate;
ammonium nitrate;
calcium ammonium nitrate;
ammonium sulphate nitrate;
calcium cyanamide;
urea ammonium nitrate solution;
nitrophosphate;
mono ammonium phosphate;
diammonium phosphate; and,
liquid ammonium polyphosphates, as well as combinations and mixtures thereof.

20. The method of claim 18 wherein the nutrient component further comprises potash fertilizer.

21. The method of claim 20 wherein the potash fertilizer is a member of a group consisting of potassium chloride, potassium sulphate, and potassium magnesium sulphate as well as combinations and mixtures thereof.

22. The method of claim 18 wherein the nutrient component further comprises phosphorous.

23. The method of claim 18 wherein the colorant component further comprises a water-based lawn paint.
